(19) United States
(12) Patent Application Publication
(10) Pub. No.: US 2022/0114583 A1
(43) Pub. Date: Apr. 14, 2022

(54) BLOCKCHAIN BASED SERVICE INFORMATION PROCESSING METHOD, DEVICE AND READABLE STORAGE MEDIUM

(71) Applicant: JINGDONG TECHNOLOGY HOLDING CO.,LTD., BEIJING (CN)

(72) Inventor: Erbao NIE, Beijing (CN)

(21) Appl. No.: 17/559,464

(22) Filed: Dec. 22, 2021

Related U.S. Application Data
(63) Continuation of application No. PCT/CN2020/079531, filed on Mar. 16, 2020.

(30) Foreign Application Priority Data
Jun. 28, 2019 (CN) 201910573416.5

(51) Int. Cl. G06Q 20/38; G06Q 20/40

(52) U.S. Cl. CPC G06Q 20/389; G06Q 20/4016

(57) ABSTRACT

The present disclosure provides a blockchain based service information processing method, a device and a readable storage medium. The method includes: a supervision node sending a voting request in a blockchain, where the voting request includes service information and a voting option, and the blockchain includes the supervision node and at least one evaluation node; the supervision node generating a block after a preset time according to all voting results verified by a verification node, and uploading the block to the blockchain, where the verification node is elected from the at least one evaluation node; and the supervision node determining, according to all the voting results, whether or not to enter a risk evaluation process. Therefore, it is possible to quickly determine whether to evaluate the risk of a service and the loss caused to a user is avoided.

This application is a continuation of International Application No. PCT/CN2020/079531, filed on Mar. 16, 2020, which claims priority to Chinese Patent Application No. 201910573416.5, filed on Jun. 28, 2019, both of the applications are hereby incorporated by reference in their entireties.

### TECHNICAL FIELD

The present disclosure relates to the field of blockchain and, in particular, to a blockchain based service information processing method, a device and a readable storage medium.

### BACKGROUND

With the development of the Internet, more and more innovative services have emerged in recent years. On the one hand, the emergence of innovative services can promote the development of economy and technology, but on the other hand, some of the innovative services may also result in violations of laws or cause economic losses to users.

In order to minimize losses caused by innovative services to users, in prior arts, a supervision organization generally determines that an innovative service is of risk after the innovative service has caused losses to users, and immediately takes predetermined punitive measures to handle the innovative service.

However, the use of punitive measures to handle an innovative service can only serve a remedial effect, but cannot evaluate a risk of the innovative service beforehand. To a certain extent, losses will still be incurred to its users, leading to a poor user experience.

### SUMMARY

One objective of the present disclosure is to provide a blockchain based service information processing method, a device and a readable storage medium, which are intended to address the technical problem that an existing method for processing an innovative service can only serve a remedial effect, but cannot evaluate a risk of the innovative service beforehand.

In a first aspect, the present disclosure provides a blockchain based service information processing method, including:

sending, by a supervision node, a voting request in a blockchain, where the voting request includes service information and a voting option, and the blockchain includes the supervision node and at least one evaluation node;

generating, by the supervision node, a block after a preset time according to all voting results verified by a verification node, and uploading the block to the blockchain, where the verification node is elected from the at least one evaluation node;

and determining, by the supervision node, according to all the voting results, whether or not to enter a risk evaluation process.

According to the blockchain based service information processing method provided in the embodiment, a blockchain is built, as soon as a supervision node detects generation of a new service, it issues a voting request in the blockchain for a risk evaluation on the service, generates a block according to all voting results verified by a verification node, and performs a risk evaluation according to all the voting results in the block, thereby, it is possible to quickly determine whether or not to evaluate the risk of the service and the loss caused to a user is avoided.

In a possible design, where the issuing, according to the preset smart contract, the rewards to all the evaluation nodes that participate in the voting, includes:

determining, from all the voting results, an optimal voting option with a highest voting count; and

issuing the rewards to the evaluation nodes according to closeness of voting options of the evaluation nodes to the optimal voting option, where the optimal voting option corresponds to a highest reward.

According to the blockchain based service information processing method provided in the embodiment, the optimal voting option with the highest voting count in all the voting results is determined, and the rewards are issued to the evaluation nodes according to closeness of voting options of the evaluation nodes to the optimal voting option, where the optimal voting option corresponds to the highest reward. Thereby, an evaluation node can be encouraged to actively vote on the voting request, and a basis for whether to perform an evaluation on a service risk is provided.

In a second aspect, the present disclosure provides a blockchain based service information processing method, including:

receiving, by an evaluation node, a voting request issued in a blockchain by a supervision node;

broadcasting, by the evaluation node, a voting result in the blockchain according to the voting request; and

electing, by the evaluation node, at least one verification node according to a preset election mechanism such that the verification node verifies all voting results, and uploads to the blockchain; such that the supervision node generates a block according to all the voting results verified by the verification node, and determines, according to all the voting results, whether or not to enter a risk evaluation process.

According to the blockchain based service information processing method provided in the embodiment, a blockchain is built, after receiving a voting request issued by a supervision node for a risk evaluation on a service, an evaluation node votes on the voting request, broadcasts to the blockchain, and selects at least one verification node to verify voting results and generates a block according to all the voting results verified by the verification node. Further, whether or not to enter a risk evaluation process is determined according to all the voting results in the block. Thereby, it is possible to quickly determine whether or not to evaluate the risk of the service and the loss caused to a user is avoided.

In a possible design, where the electing, by the evaluation node, the at least one verification node according to the preset election mechanism, includes:

determining a quantity of all evaluation nodes that participate in voting and a random number that satisfies a preset condition, where the random number is less than the quantity of all the evaluation nodes that participate in the voting; and

selecting, from the evaluation nodes, an evaluation node whose quantity is a difference between the quantity of all the evaluation nodes that participate in the voting and the random number to be the at least one verification node.

According to the blockchain based service information processing method provided in the embodiment, from the evaluation nodes, an evaluation node whose quantity is a difference between the quantity of all the evaluation nodes that participate in the voting and the random number is selected to be the at least one verification node. Thereby, on the basis that the verification of the voting results is achieved, the fairness of the verification process is improved.

In a third aspect, the present disclosure provides a blockchain based service information processing method, including:

obtaining, by a verification node, voting results sent by all evaluation nodes in a blockchain, where the verification node is elected by all the evaluation nodes in the blockchain that participate in voting;

verifying, by the verification node, the voting results with respect to each of the voting results; and

generating, by the verification node, a block according to the verified voting results and uploading the block to the blockchain, such that a supervision node generates a block according to all the voting results verified by the verification node, and determines, according to all the voting results, whether or not to enter a risk evaluation process.

According to the blockchain based service information processing method provided in the embodiment, a blockchain is built, after an evaluation node receives a voting request issued by a supervision node for a risk evaluation on a service, votes on the voting request, and broadcasts to the blockchain, an verification node elected verifies voting results and generates a block according to all the voting results verified, such that a supervision node generates a block again according to the voting results verified, uploads the block to the blockchain, and determines, according to all the voting results in the block, whether or not to enter a risk evaluation process. Thereby, it is possible to quick determine whether or not to evaluate the risk of the service and the loss caused to a user is avoided.

In a fourth aspect, the present disclosure provides a supervision node, including:

a voting request sending module, configured to send a voting request in a blockchain, where the voting request includes service information and a voting option, and the blockchain includes the supervision node and at least one evaluation node;

a first block generating module, configured to generate a block after a preset time according to all voting results verified by a verification node, and upload the block to the blockchain, where the verification node is elected from the at least one evaluation node; and

a risk evaluating module, configured to determine, according to all the voting results, whether or not to enter a risk evaluation process.

According to the supervision node provided in the embodiment, a blockchain is built, as soon as a supervision node detects generation of a new service, it issues a voting request in the blockchain for a risk evaluation on the service, generates a block according to all voting results verified by a verification node, and performs a risk evaluation on all voting results in the block, thereby, it is possible to quickly determine whether or not to evaluate the risk of the service and the loss caused to a user is avoided.

In a fifth aspect, the present disclosure provides an evaluation node, including:

a voting request receiving module, configure to receive a voting request issued in a blockchain by a supervision node;

a broadcasting module, configured to broadcast a voting result in the blockchain according to the voting request; and

an electing module, configured to elect at least one verification node according to a preset election mechanism such that the verification node verifies all voting results, and uploads to the blockchain; such that the supervision node generates a block according to all the voting results verified by the verification node, and determines, according to all the voting results, whether or not to enter a risk evaluation process.

According to the evaluation node provided in the embodiment, a blockchain is built, after receiving a voting request issued by a supervision node for a risk evaluation on a service, an evaluation node votes on the voting request, broadcasts to the blockchain, and selects at least one verification node to verify voting results and generates a block according to all the voting results verified by the verification node. Further, whether or not to enter a risk evaluation process is determined according to all the voting results in the block. Thereby, it is possible to quickly determine whether or not to evaluate the risk of the service and the loss caused to a user is avoided.

In a sixth aspect, the present disclosure provides a verification node, including:

an evaluation result obtaining module, configured to obtain evaluation results sent by all evaluation nodes in a blockchain, where the verification node is elected by all the evaluation nodes in the blockchain that participate in voting;

a verification module, configured to verify the voting results with respect to each of the voting results; and

a second block generating module, configured to generate a block according to the verified voting results and upload the block to the blockchain, such that a supervision node generates a block according to all the voting results verified by the verification node, and determines, according to all the voting results, whether or not to enter a risk evaluation process.

According to the verification node provided in the embodiment, a blockchain is built, after an evaluation node receives a voting request issued by a supervision node for a risk evaluation on a service, votes on the voting request, and broadcasts to the blockchain, an verification node elected verifies voting results and generates a block according to all the voting results verified, such that a supervision node generates a block again according to the voting results verified, uploads the block to the blockchain, and determines, according to all the voting results in the block, whether or not to enter a risk evaluation process. Thereby, it is possible to quickly determine whether or not to evaluate the risk of the service and the loss caused to a user is avoided.

In a seventh aspect, the present disclosure provides a supervision node, including: a memory and a processor; where,

the memory is configured to store instructions executable by the processor;

the processor is configured to execute the blockchain based service information processing method according to the first aspect.

In an eighth aspect, the present disclosure provides an evaluation node, including: a memory and a processor; where,

the memory is configured to store instructions executable by the processor;

the processor is configured to execute the blockchain based service information processing method according to the second aspect.

In a ninth aspect, the present disclosure provides a verification node, including: a memory and a processor; where,

the memory is configured to store instructions executable by the processor;

the processor is configured to execute the blockchain based service information processing method according to the third aspect.

In a tenth aspect, the present disclosure provides a computer readable storage medium, storing thereon computer executable instructions, where the blockchain based service information processing method according to the first aspect, the second aspect or the third aspect is implemented when the computer executable instructions are executed by a processor.

According to the blockchain based service information processing method, the device and the readable storage medium provided in the present disclosure, a blockchain is built, as soon as a supervision node detects generation of a new service, it issues a voting request in the blockchain for a risk evaluation on the service, generates a block according to all voting results verified by a verification node, and performs a risk evaluation on all voting results in the block, thereby, it is possible to quickly determine whether or not to evaluate the risk of the service and the loss caused to a user is avoided.

### BRIEF DESCRIPTION OF DRAWINGS

FIG. 1 is a schematic flowchart of a blockchain based service information processing method according to a first embodiment of the present disclosure;

FIG. 2 is a schematic flowchart of a blockchain based service information processing method according to a second embodiment of the present disclosure;

FIG. 3 is a schematic flowchart of a blockchain based service information processing method according to a third embodiment of the present disclosure;

FIG. 4 is a schematic flowchart of a blockchain based service information processing method according to a fourth embodiment of the present disclosure;

FIG. 5 is a schematic flowchart of a blockchain based service information processing method according to a fifth embodiment of the present disclosure;

FIG. 6 is a structural schematic diagram of a supervision node according to a sixth embodiment of the present disclosure;

FIG. 7 is a structural schematic diagram of an evaluating node according to a seventh embodiment of the present disclosure;

FIG. 8 is a structural schematic diagram of a verification node according to an eighth embodiment of the present disclosure;

FIG. 9 is a structural schematic diagram of a supervision node according to a ninth embodiment of the present disclosure;

FIG. 10 is a structural schematic diagram of an evaluating node according to a tenth embodiment of the present disclosure; and

FIG. 11 is a structural schematic diagram of a verification node according to an eleventh embodiment of the present disclosure.

### DESCRIPTION OF EMBODIMENTS

In order to make the purpose, technical solutions and advantages of the present disclosure clearer, the technical solutions in the embodiments of the present disclosure will be described hereunder clearly and comprehensively in conjunction with the accompanying drawings of the embodiments of the present disclosure. Obviously, the described embodiments are some of, rather than all of the embodiments of the present disclosure. All other embodiments obtained based on the embodiments in the present disclosure shall fall within the protection scope of present disclosure.

With respect to the above-mentioned technical problem that an existing method for processing an innovative service can only serve a remedial effect, but cannot evaluate a risk of the innovative service beforehand, the present disclosure provides a blockchain based service information processing method, a device and a readable storage medium.

It should be noted that the blockchain based service information processing method, the device and the readable storage medium provided in the present disclosure can be used in a risk evaluation scenario of any service.

First, a term that is related to the present disclosure is explained:

Blockchain: a blockchain is a new application mode of computer technologies such as distributed data storage, point-to-point transmission, consensus mechanisms and encryption algorithms.

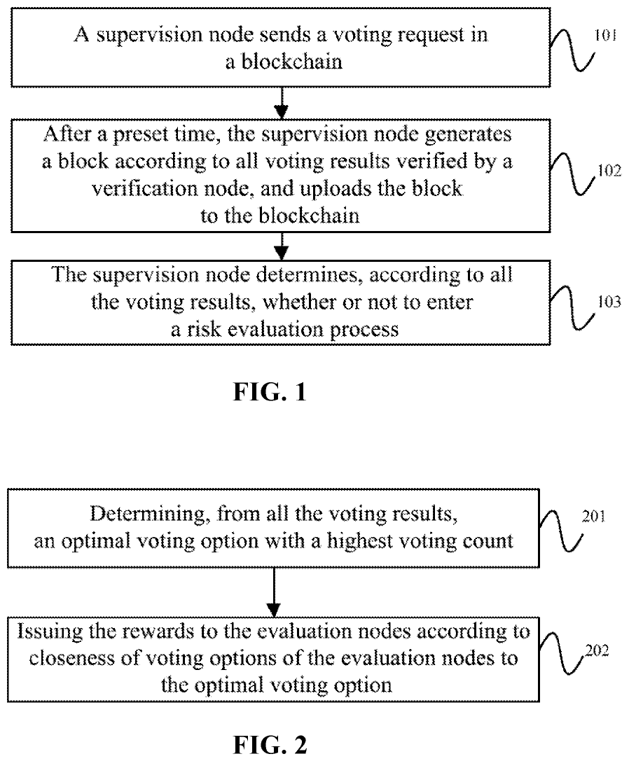

FIG. 1 is a schematic flowchart of a blockchain based service information processing method according to a first embodiment of the present disclosure. As shown in FIG. 1, the method includes:

Step 101, a supervision node sends a voting request in a blockchain, where the voting request includes service information and a voting option, and the blockchain includes the supervision node and at least one evaluation node.

The execution body of the embodiment is a supervision node which may be a user terminal or a server. In order to achieve a risk evaluation on a service, it is necessary to establish a blockchain first. The blockchain includes the supervision node and at least one evaluation node, where the supervision node is a service supervision organization, and the evaluation node may be people who participate in the voting of service evaluation. Specifically, the supervision node may issue a voting request in the blockchain. The voting request may include service information of an innovative service subject to risk evaluation and a voting option. For example, the voting option may include yes/no, excellent/good/medium/poor or any other evaluation mechanism to enable the evaluation node to understand the voting rules according to the voting option. In addition, the voting request may further include a total reward amount and a reward policy corresponding to the voting request, a voting request deadline and the identification of the supervision organization that initiated the voting request, so that more evaluation nodes may be encouraged to vote by means of issuing rewards. The total reward amount, the reward policy and the voting request deadline are written into a smart contract in advance.

It should be noted that the foregoing innovative service may be a service of any field. For example, it may be an innovative service in finance, which is not limited in the present disclosure.

Furthermore, on the basis of any of the foregoing embodiments, the voting request is sent after the supervision node detects generation of a new service.

In the embodiment, the voting request is sent to the blockchain by the supervision node upon detecting generation of a new service. Specifically, the supervision node may detect, through a preset detection method, whether there is a new service generated. For example, it may regularly detect whether there is a new service APP launched online, or it may use any other detection method to detect a new service, which is not limited in the present disclosure. It should be noted when the supervision node detects generation of a new service, it immediately sends the voting request in the blockchain, so that it is possible to effectively avoid the loss to a user due to late supervision of the service.

Step 102, after a preset time, the supervision node generates a block according to all voting results verified by a verification node, and uploads the block to the blockchain, where the verification node is elected from the at least one evaluation node.

In the embodiment, on receiving the voting request, all the evaluation nodes in the blockchain may vote according to the voting request, and broadcast voting results to the blockchain. In order to verify the legitimacy of the voting results, at least one verification node is required to be elected to verify the voting results. It should be noted that the preset time of a voting deadline has been written in the smart contract in advance, therefore, after the preset time, the supervision node can obtain all voting results verified by the verification node, generate a block according to all the voting results, and link the block to the blockchain.

Step 103: the supervision node determines, according to all the voting results, whether or not to enter a risk evaluation process.

In the embodiment, after the supervision node generates a block according to the verified voting results and links the block to the blockchain, it may determine, according to the voting information in the block, whether or not to evaluate the risk of the service. Taking a practical application as an example, if there are presently 100 voting results, of which 80 are graded as excellent, 10 are graded as good, 6 are graded as medium and 4 are graded as poor. Since the medium evaluations and higher evaluations accounts for the majority, at this time, it may be determined that the service is of a low risk, therefore, it is not necessary to perform a risk evaluation on the service. In an implementation, in order to help supervision personnel to determine more intuitively whether or not to evaluate the risk of the service, the voting results may be displayed in the form of statistical chart. Furthermore, after the risk of the service is determined, supervision measures corresponding to the risk may be taken to handle the service according to the risk of the service.

It should be noted that in the prior art, due to cost or other reasons, it is impossible for a supervision organization to determine problems that an innovative service of a financial institution may bring about through a large-scale investigation and research, and there is no reasonable and scientific mechanism to assess the impact of such problems. Therefore, data and information are often collected through existing technical means for evaluation, which provides a basis for taking supervision measures, and which is apparently very limited from a perspective of information acquisition and has obvious limitations. According to the foregoing method, a large amount of evaluation information may be obtained through voting by multiple evaluation nodes, thereby, the problem in the prior art that the supervision method has limitations can be effectively solved.

In addition, supervision measures, due to their strong constraints on service activities of a financial institution, once implemented, will take an immediate effect which may result in a drastic consequence and bring out a hardly estimable impact. Moreover, due to “offensiveness”, the measures may frustrate financial innovations and add pressure on the information of the financial market, and thus an opposite effect may be rendered. However, according to the foregoing method, a supervision method corresponding to a risk is adopted with respect to different service risks, thereby, the offensiveness caused by the existing supervision method can be avoided effectively.

According to the blockchain based service information processing method provided in the embodiment, a blockchain is built, as soon as a supervision node detects generation of a new service, it issues a voting request in the blockchain for a risk evaluation on the service, generates a block according to all voting results verified by a verification node, and performs a risk evaluation on all voting results in the block, thereby, it is possible to quickly determine whether or not to evaluate the risk of the service and the loss caused to a user is avoided.

Furthermore, on the basis of any of the foregoing embodiments, after the supervision node generates the block according to all the voting results verified by the verification node and uploads the block to the blockchain, the method further includes:

issuing, according to a preset smart contract, rewards to all evaluation nodes that participate in voting.

In the embodiment, in order to encourage an evaluation node to actively vote on the voting request, a reward issuing policy may be written in the smart contract in advance. Therefore, after the supervision node generates the block according to all the voting results verified by the verification node and uploads the block to the blockchain, it may issue rewards to all evaluation nodes that participate in voting according to a preset smart contract.

According to the blockchain based service information processing method provided in the embodiment, rewards are issued, according to a preset smart contract, to all evaluation nodes that participate in voting, thereby, an evaluation node is encouraged to actively vote on the voting request, and a basis for an evaluation on a service risk is provided.

FIG. 2 is a schematic flowchart of a blockchain based service information processing method according to a second embodiment of the present disclosure. On the basis of any of the foregoing embodiments. As shown in FIG. 2, the issuing, according to the preset smart contract, the rewards to all the evaluation nodes that participate in the voting, includes:

Step 201, determining, from all the voting results, an optimal voting option with a highest voting count; and

Step 202, issuing the rewards to the evaluation nodes according to closeness of voting options of the evaluation nodes to the optimal voting option, where the optimal voting option corresponds to a highest reward.

In the embodiment, different reward amounts may be set for different voting options. Specifically, an optimal voting option with a highest voting count may be determined from all the voting results, and the rewards may be issued to the evaluation nodes according to closeness of voting options of the evaluation nodes to the optimal voting option, where the optimal voting option corresponds to a highest reward. Taking a practical application as an example, if there are presently 100 voting results, of which 80 are graded as excellent, 10 are graded as good, 6 are graded as medium and 4 are graded as poor, then the optimal voting option is falls under the excellent grade. In this case, the evaluation nodes whose voting option is graded as excellent get the highest reward amount, the evaluation nodes whose voting option is graded as good take the second place, and the evaluation nodes whose voting option is graded as poor get the least reward. Specifically, the reward may be calculated through formulas 1-3:

i the optimal voting option=m/Σm excellent,good,medium,poor (1)

Ω the optimal voting option=(1+i)*Ω/Σm excellent,good,medium,poor (2)

Ω the other voting options=(Ω−Ω the optimal voting option*Σm the optimal voting option)/Σm other voting options (3)

where m is the quantity of evaluation nodes whose voting results belong to the optimal voting option, Σm is the total number of evaluation nodes participating in voting, i the optimal voting option is the weight value corresponding to the optimal voting option, Ω the optimal voting option is the total reward corresponding to the optimal voting option, and Ω the other voting options is the total reward of the other voting options.

According to the blockchain based service information processing method provided in the embodiment, an optimal voting option with a highest voting count is determined from all the voting results, and the rewards are issued to the evaluation nodes according to closeness of voting options of the evaluation nodes to the optimal voting option, where the optimal voting option corresponds to a highest reward. Thereby, an evaluation node is encouraged to actively vote on the voting request, and a basis for whether to perform an evaluation on a service risk is provided.

Optionally, on the basis of any of the foregoing embodiments, the issuing, according to the preset smart contract, the rewards to all the evaluation nodes that participate in the voting, includes:

determining proportion information of each voting option in all the voting results; and

issuing the rewards to the evaluation nodes according to the proportion information.

In the embodiment, different reward amounts may be set for different voting options. Specifically, proportion information of each voting option in all the voting results may be determined, and the rewards may be issued to the evaluation nodes according to the proportion information. The higher proportion the voting options account for, the higher reward the evaluation node corresponding to each of the voting options gets.

According to the blockchain based service information processing method provided in the embodiment, proportion information of each voting option in all the voting results is determined, and the rewards are issued to the evaluation nodes according to the proportion information. Thereby, an evaluation node is encouraged to actively vote on the voting request, and a basis for whether to perform an evaluation on a service risk is provided.

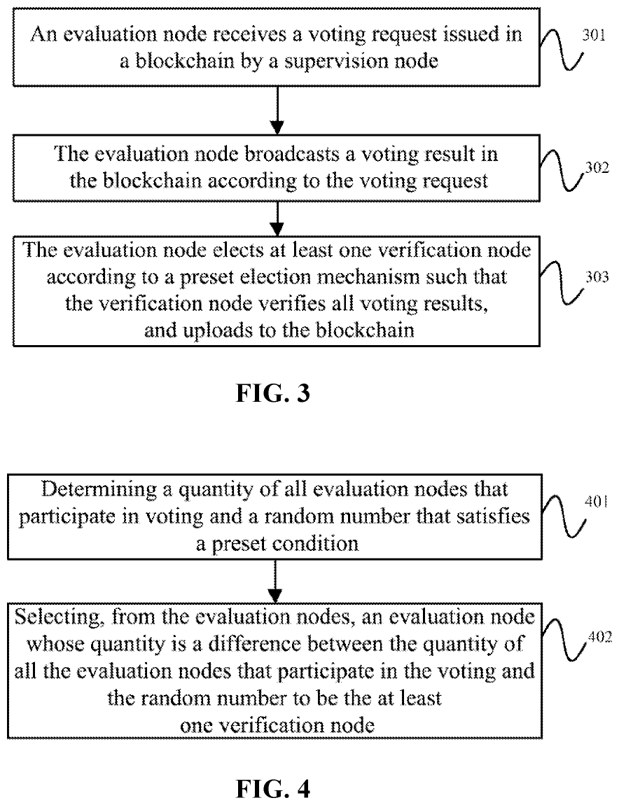

FIG. 3 is a schematic flowchart of a blockchain based service information processing method according to a third embodiment of the present disclosure. As shown in FIG. 3. The method includes:

Step 301, an evaluation node receives a voting request issued in a blockchain by a supervision node;

Step 302, the evaluation node broadcasts a voting result in the blockchain according to the voting request; and

Step 303, the evaluation node elects at least one verification node according to a preset election mechanism such that the verification node verifies all voting results, and uploads to the blockchain; such that the supervision node generates a block according to all the voting results verified by the verification node, and determines, according to all the voting results, whether or not to enter a risk evaluation process.

The execution body of the embodiment is an evaluation node. In order to perform evaluation on a risk of a service, it is necessary to establish a blockchain first. The blockchain includes the supervision node and at least one evaluation node, where the supervision node is a service supervision organization, and the evaluation node may be people who participate in the voting of service evaluation. Specifically, the supervision node may issue a voting request in the blockchain. Correspondingly, the evaluation node may receive the voting request, where the voting request includes service information, voting options, a total reward amount and a reward policy corresponding to the voting request, a deadline of the voting request and the identification of the supervision organization that initiated the voting request. Therefore, the evaluation node may vote according to the voting request, and after voting, sign the voting result through its own private key and broadcast it to the blockchain. At this time, in order to verify the legitimacy of each voting result, the evaluation node may elect at least one verification node according to a preset election mechanism such that the verification node may verify the voting results, generate a block according to the verified voting results and upload it to the blockchain. After all the voting results are verified, the supervision node may generate a block according to all the verified voting results and upload the block to the blockchain, and subsequently, determine whether or not to evaluate the risk of the service according to all the voting results.

According to the blockchain based service information processing method provided in the embodiment, a blockchain is built, after receiving a voting request issued by a supervision node for a risk evaluation on a service, an evaluation node votes on the voting request, broadcasts to the blockchain, and selects at least one verification node to verify voting results and generates a block according to all the voting results verified by the verification node. Further, whether or not to enter a risk evaluation process is determined according to all the voting results in the block. Thereby, it is possible to quickly determine whether or not to evaluate the risk of the service and the loss caused to a user is avoided.

FIG. 4 is a schematic flowchart of a blockchain based service information processing method according to a fourth embodiment of the present disclosure. On the basis of any of the foregoing embodiments, the evaluation node electing the at least one verification node according to the preset election mechanism, includes:

Step 401, determining a quantity of all evaluation nodes that participate in voting and a random number that satisfies a preset condition, where the random number is less than the quantity of all the evaluation nodes that participate in the voting; and

Step 402, selecting, from the evaluation nodes, an evaluation node whose quantity is a difference between the quantity of all the evaluation nodes that participate in the voting and the random number to be the at least one verification node.

In the embodiment, in order to verify the legitimacy of each voting result, the evaluation node may elect at least one verification node according to a preset election mechanism. Specifically, first, a quantity of all evaluation nodes that participate in voting and a random number that satisfies a preset condition may be determined, where the random number is less than the quantity of all the evaluation nodes that participate in the voting. The random number n and the quantity m of all the evaluation nodes that participate in the voting may satisfy the following relationship: m−n<m/3, and m−n is an odd number. It should be noted that the larger the quantity of the verification nodes is, the more accurate a verification result is, and consequently, the greater the pressure for the system is. Therefore, the random number may be set according to an actual situation, which is not limited in the present disclosure. For example, when the system processing capacity is poor, one verification node may be set, whereas when the system processing capacity is strong, multiple verification nodes may be set. From the evaluation nodes, an evaluation node whose quantity is a difference between the quantity of all the evaluation nodes that participate in the voting and the random number is selected to be the at least one verification node. Since the random number is uncertain, the selected verification nodes also have randomness, therefore the fairness of the verification process is guaranteed.

According to the blockchain based service information processing method provided in the embodiment, an evaluation node whose quantity is a difference between the quantity of all the evaluation nodes that participate in the voting and the random number is selected, from the evaluation nodes, to be the at least one verification node. Thereby, on the basis that the verification of the voting results is achieved, the fairness of the verification process may be improved.

Furthermore, on the basis of any of the foregoing embodiments, after the selecting, from the evaluation nodes, the evaluation node whose quantity is the difference between the quantity of all the evaluation nodes that participate in the voting and the random number to be the at least one verification node, the method further includes:

selecting an accounting verification node from the at least one verification node through a preset consensus mechanism, such that the accounting verification node generates a block according to all the voting results and link the block to the blockchain.

In the embodiment, if there is one verification node, the verification node may be an accounting verification node. After verification, the verification node may directly upload the verified voting results to the blockchain. If there are multiple verification nodes, each of the verification nodes may verify the voting results, but not each of the verification nodes has accounting right. In this case, an accounting verification node may be selected from the at least one verification node through the preset consensus mechanism, such that after each of the verification nodes completes the verification, the accounting verification node uploads all voting results to the blockchain. It should be noted that any consensus mechanism may be used to determine the accounting verification node, which is not limited in the present disclosure.

According to the blockchain based service information processing method provided in the embodiment, an accounting verification node is selected from the at least one verification node through a preset consensus mechanism, such that the accounting verification node generates a block according to all the voting results and link the block to the blockchain. Thereby, the determination of the accounting verification node can be achieved, and a basis for whether to subsequently perform an evaluation on a service risk is provided.

Furthermore, on the basis of any of the foregoing embodiments, the determining the quantity of all the evaluation nodes that participate in the voting and the random number, includes:

with respect to each preset time span, determining the quantity of all the evaluation nodes that participate in the voting and the random number.

In the embodiment, because there are many evaluation nodes for voting and the total time span for voting is long, in order to further improve the efficiency of risk evaluation and avoid the loss caused to a user due to lagging, the total voting time may be divided into multiple time spans. For example, if the total voting time span is three days, the total voting time span may be divided into three time spans in which verification will be performed every day. Accordingly, with respect to each of the time spans, at least one verification node needs to be selected. Therefore, with respect to each preset time span, a quantity of all the evaluation nodes that participate in voting and a random number may be determined, a quantity of verification nodes may be determined according to the quantity of all the evaluation nodes that participate in the voting and the random number, and verification nodes corresponding to the quantity may be determined randomly.

According to the blockchain based service information processing method provided in the embodiment, the total voting time is divided into multiple time spans, with respect to each preset time span, a quantity of all the evaluation nodes that participate in voting and a random number may be determined, a quantity of verification nodes may be determined according to the quantity of all the evaluation nodes that participate in the voting and the random number, and verification nodes corresponding to the quantity may be determined randomly. Thereby, the efficiency of risk evaluation can be improved effectively, and the loss caused to a user due to lagging is avoided. In addition, since all the voting results are processed in batches, the pressure to a processor of a verification node can be reduced effectively, and thus the efficiency of verification is improved.

Furthermore, on the basis of any of the foregoing embodiments, the evaluation node needs to send acknowledge information after being selected as a verification node.

Accordingly, after the selecting, from the evaluation nodes, the evaluation node whose quantity is the difference between the quantity of all the evaluation nodes that participate in the voting and the random number to be the at least one verification node, the method further includes:

if it is detected that any one of the verification node does not send acknowledge information after a preset time threshold, returning to execution of the step of the determining the quantity of all the evaluation nodes that participate in the voting and the random number, until acknowledge information sent by each of the verification node is received.

In the embodiment, in order to further improve the efficiency of verification, any evaluation node, after being selected as a verification node, needs to send acknowledge information to ensure that the voting results can be verified in time. Accordingly, if it is detected that any verification node does not send the acknowledge information after the preset time threshold, return to execution of the step of the determining the quantity of all the evaluation nodes that participate in the voting and the random number, until acknowledge information sent by each of the verification node is received.

According to the blockchain based service information processing method provided in the embodiment, if it is detected that any one of the verification node does not send acknowledge information after a preset time threshold, return to execution of the step of the determining the quantity of all the evaluation nodes that participate in the voting and the random number, until acknowledge information sent by each of the verification node is received. Thereby, it can be ensured that a verification node elected may verify voting results in time to improve the efficiency of verification, in addition, the lagging problem is further solved such that the loss caused to a user is avoided.

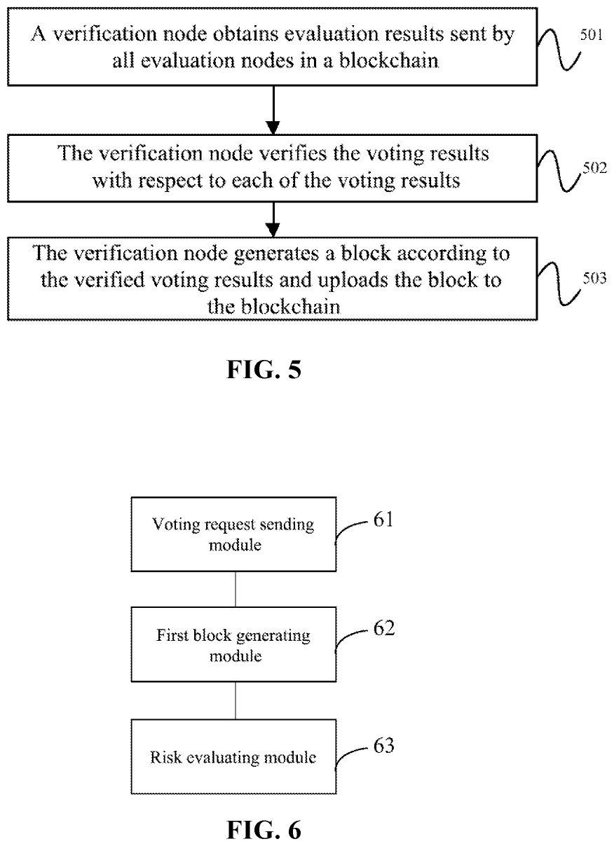

FIG. 5 is a schematic flowchart of a blockchain based service information processing method according to a fifth embodiment of the present disclosure. As shown in FIG. 5, the method includes:

Step 501, a verification node obtains voting results sent by all evaluation nodes in a blockchain, where the verification node is elected by all the evaluation nodes in the blockchain that participate in voting;

Step 502, the verification node verifies the voting results with respect to each of the voting results; and

Step 503, the verification node generates a block according to the verified voting results and uploads the block to the blockchain, such that a supervision node generates a block according to all the voting results verified by the verification node, and determines, according to all the voting results, whether or not to enter a risk evaluation process.

The execution body of the embodiment is a verification node. In order to achieve a risk evaluation on a service, it is necessary to establish a blockchain first. The blockchain includes the supervision node and at least one evaluation node, where the supervision node is a service supervision organization, and the evaluation node may be people who participate in the voting of service evaluation. Specifically, the supervision node may issue a voting request in the blockchain. Correspondingly, the evaluation node may receive the voting request, where the voting request includes service information, voting options, a total reward amount and a reward policy corresponding to the voting request, a deadline of the voting request and the identification of the supervision organization that initiated the voting request. Therefore, the evaluation node may vote according to the voting request, and after voting, sign the voting result through its own private key and broadcast to the blockchain. In order to verify the legitimacy of each voting result, the evaluation node may elect at least one verification node according to a preset election mechanism. At this time, the verification node may obtain voting results sent by all evaluation nodes, verify the voting results with respect to each of the voting results, and generate a block according to the verified voting results and link the block to the blockchain, such that the supervision node generates a block according to all the voting results verified by the verification node, and determine, according to all the voting results, whether or not to enter a risk evaluation process.

According to the blockchain based service information processing method provided in the embodiment, a blockchain is built, after an evaluation node receives a voting request issued by a supervision node for a risk evaluation on a service, votes on the voting request, and broadcasts to the blockchain, an verification node elected verifies voting results and generates a block according to all the voting results verified, such that a supervision node generates a block again according to the voting results verified, uploads the block to the blockchain, and determines, according to all the voting results in the block, whether or not to enter a risk evaluation process. Thereby, it is possible to quickly determine whether or not to evaluate the risk of the service and the loss caused to a user is avoided.

Furthermore, on the basis of any of the foregoing embodiments, the voting results include identifiers of evaluation nodes that broadcast the voting results.

Accordingly, the verifying, by the verification node, the voting results with respect to each of the voting results, includes:

determining the evaluation nodes that broadcast the voting results according to the identifiers of the evaluation nodes in the voting results; and

verifying the voting results according to prestored public keys of the evaluation nodes.

In the embodiment, the voting results include identifiers of evaluation nodes that broadcast the voting results. Therefore, after the voting results are obtained, the evaluation nodes that broadcast the voting results may firstly be determined according to the identifiers of the evaluation nodes, and the voting results may be verified according to prestored public keys of the evaluation nodes.

According to the blockchain based service information processing method provided in the embodiment, the evaluation nodes that broadcast the voting results are determined according to the identifiers of the evaluation nodes, and the voting results are verified according to prestored public keys of the evaluation nodes. Thereby, it is possible to effectively determine whether or not to verify the voting results, and the security of the risk evaluation is improved.

Furthermore, on the basis of any of the foregoing embodiments, the verifying, by the verification node, the voting results with respect to each of the voting results, includes:

verifying, by the verification node, the voting results with respect to each of the voting results in a preset time span.

In the embodiment, because there are many evaluation nodes for voting and the total time span for voting is long, in order to further improve the efficiency of risk evaluation and avoid the loss caused to a user due to lagging, the total voting time may be divided into multiple time spans. Accordingly, with respect to each of the time spans, at least one verification node needs to be selected. Therefore, with respect to each preset time span, a quantity of all the evaluation nodes that participate in voting and a random number may be determined, a quantity of verification nodes may be determined according to the quantity of all the evaluation nodes that participate in the voting and the random number, and verification nodes corresponding to the quantity may be determined randomly. And the verification node verifies each of the voting results in a preset time span.

According to the blockchain based service information processing method provided in the embodiment, the total voting time is divided into multiple time spans. Verification is performed with respect to each of the voting results in each of the preset time spans. Thereby, the efficiency of risk evaluation can be improved effectively, and the loss caused to a user due to lagging is avoided. In addition, since all the voting results are processed in batches, the pressure to a processor of a verification node can be reduced effectively, and thus the efficiency of verification is improved.

Furthermore, on the basis of any of the foregoing embodiments, the generating, by the verification node, the block according to the verified voting results and the uploading the block to the blockchain, include:

generating, by the verification node, the block according to the verified voting results and uploading the block to a main chain of the blockchain; or,

generating, by the verification node, the block according to the verified voting results and uploading the block to preset branch chains;

where the generating, by the verification node, the block according to the verified voting results and uploading the block to preset branch chains, includes: before the supervision node generates the block according to all the voting results verified by the verification node, when a main chain of the blockchain verifies validity of the branch chains by verifying a Merkle tree of a part of the branch chains and the validity of the branch chains is verified, generating, by the verification node, the block according to all the voting results verified by the verification node, and uploading the block to the part of the branch chains.

In the embodiment, the block generated according to the verified voting results may be directly linked to a main chain of the blockchain. Alternatively, in order to reduce the pressure to the main chain, it may also be linked to branch chains. Specifically, the verification node may generate the block according to the verified voting results and upload the block to a main chain of the blockchain. In an implementation, the verification node generates the block according to the voting results verified, and uploads the block to preset branch chains. It should be noted that before the supervision node generates the block according to all the voting results verified by the verification node, the main chain needs to verify validity of the branch chains, where the determination of the validity of the branch chains may be specifically realized by verifying a Merkle tree of a part of the branch chains.

According to the blockchain based service information processing method provided in the embodiment, a block is generated according to the verified voting results and uploaded to a main chain of the blockchain; or a block is generated according to the verified voting results and uploaded to preset branch chains, and before the supervision node generates the block according to all the voting results verified by the verification node, when a main chain of the blockchain verifies validity of the branch chains by verifying a Merkle tree of a part of the branch chains and the validity of the branch chains is verified, the block is generated according to all the voting results verified by the verification node. Thereby, on the basis that the pressure to the main chain is reduced, the security of the main chain can be ensured.

FIG. 6 is a structural schematic diagram of a supervision node according to a sixth embodiment of the present disclosure. As shown in FIG. 6, the supervision node includes:

a voting request sending module 61, configured to send a voting request in a blockchain, where the voting request includes service information and a voting option, and the blockchain includes the supervision node and at least one evaluation node;

a first block generating module 62, configured to generate a block after a preset time according to all voting results verified by a verification node, and upload the block to the blockchain, where the verification node is elected from the at least one evaluation node; and

a risk evaluating module 63, configured to determine, according to all the voting results, whether or not to enter a risk evaluation process.

According to the supervision node provided in the embodiment, a blockchain is built, as soon as a supervision node detects generation of a new service, it issues a voting request in the blockchain for a risk evaluation on the service, generates a block according to all voting results verified by a verification node, and determines, according to the voting results in the block, whether or not to enter a risk evaluation process. Thereby, it is possible to quickly determine whether or not to evaluate the risk of the service and the loss caused to a user is avoided.

Furthermore, on the basis of any of the foregoing embodiments, the voting request is sent after the supervision node detects generation of a new service.

Furthermore, on the basis of any of the foregoing embodiments, the supervision node further includes:

a reward issuing module, configured to issue, according to a preset smart contract, rewards to all evaluation nodes that participate in voting.

Furthermore, on the basis of any of the foregoing embodiments, the reward issuing module includes:

an optimal voting option determining unit, configured to determine, from all the voting results, an optimal voting option with a highest voting count; and

a first issuing unit, configured to issue the rewards to the evaluation nodes according to closeness of voting options of the evaluation nodes to the optimal voting option, where the optimal voting option corresponds to a highest reward.

Furthermore, on the basis of any of the foregoing embodiments, the reward issuing module includes:

a proportion determining unit, configured to determine proportion information of each voting option in all the voting results; and

a second issuing unit, configured to issue the rewards to the evaluation nodes according to the proportion information.

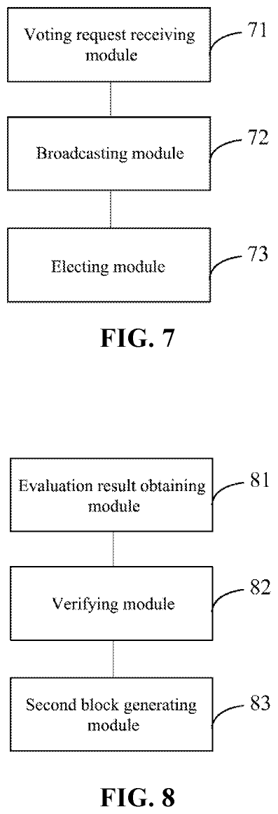

FIG. 7 is a structural schematic diagram of an evaluating node according to a seventh embodiment of the present disclosure. As shown in FIG. 7, the evaluation node includes:

a voting request receiving module 71, configure to receive a voting request issued in a blockchain by a supervision node;

a broadcasting module 72, configured to broadcast a voting result in the blockchain according to the voting request; and

an electing module 73, configured to elect at least one verification node according to a preset election mechanism such that the verification node verifies all voting results, and uploads to the blockchain; such that the supervision node generates a block according to all the voting results verified by the verification node, and determines, according to all the voting results, whether or not to enter a risk evaluation process.

According to the evaluation node provided in the embodiment, an optimal voting option with a highest voting count in all the voting results is determined, and the rewards are issued to the evaluation nodes according to closeness of voting options of the evaluation nodes to the optimal voting option, where the optimal voting option corresponds to a highest reward. Thereby, an evaluation node is encouraged to actively vote on the voting request, and a basis for an evaluation on a service risk is provided.

Furthermore, on the basis of any of the foregoing embodiments, the electing module includes:

a determining unit, configured to determine a quantity of all evaluation nodes that participate in voting and a random number that satisfies a preset condition, where the random number is less than the quantity of all the evaluation nodes that participate in the voting; and

an electing unit, configured to select, from the evaluation nodes, an evaluation node whose quantity is a difference between the quantity of all the evaluation nodes that participate in the voting and the random number to be the at least one verification node.

Furthermore, on the basis of any of the foregoing embodiments, the electing module further includes:

an accounting verification node electing unit, configured to select an accounting verification node from the at least one verification node through a preset consensus mechanism, such that the accounting verification node generates a block according to all the voting results and link the block to the blockchain.

Furthermore, on the basis of any of the foregoing embodiments, the determining unit is configured to determine, with respect to each preset time span, the quantity of all the evaluation nodes that participate in the voting and the random number.

Furthermore, on the basis of any of the foregoing embodiments, the electing module further includes:

a detecting unit, configured to detect whether there is any one of the at least one verification node which does not send acknowledge information after a preset time threshold;

a looping unit, configured to, on detecting that there is one of the at least one verification node which does not send acknowledge information after the preset time threshold, return to execution of the step of the determining the quantity of all the evaluation nodes that participate in the voting and the random number, until acknowledge information sent by each of the verification node is received; where the evaluation node sends acknowledge information after being selected as a verification node.

FIG. 8 is a structural schematic diagram of a verification node according to an eighth embodiment of the present disclosure. As shown in FIG. 8, the verification node includes:

an evaluation result obtaining module 81, configured to obtain evaluation results sent by all evaluation nodes in a blockchain, where the verification node is elected by all the evaluation nodes in the blockchain that participate in voting;

a verifying module 82, configured to verify the voting results with respect to each of the voting results; and

a second block generating module 83, configured to generate a block according to the verified voting results and upload the block to the blockchain, such that a supervision node generates a block according to all the voting results verified by the verification node, and determines, according to all the voting results, whether or not to enter a risk evaluation process.

According to the verification node provided in the embodiment, a blockchain is built, after receiving a voting request issued in a blockchain by a supervision node for a risk evaluation on a service, an evaluation node votes on the voting request, broadcasts to the blockchain, and selects at least one verification node to verify voting results and generate a block according to all the voting results verified by the verification node. Further, a risk evaluation is performed on according to all the voting results in the block. Thereby, the risk of a service is quickly evaluated and the loss caused to a user is avoided.

Furthermore, on the basis of any of the foregoing embodiments, the voting results include identifiers of evaluation nodes that broadcast the voting results;

accordingly, the verifying module includes:

an evaluation node determining unit, configured to determine the evaluation nodes that broadcast the voting results according to the identifiers of the evaluation nodes in the voting results; and

a first verifying unit, configured to verify the voting results according to prestored public keys of the evaluation nodes.

Furthermore, on the basis of any of the foregoing embodiments, the verifying module includes:

a second verifying unit, configured to verify the voting results with respect to each of the voting results in a preset time span.

Furthermore, on the basis of any of the foregoing embodiments, the second block generating module includes:

a first uploading unit, configured to generate the block according to the verified voting results and upload the block to a main chain of the blockchain; or,

a second uploading unit, configured to generate the block according to the verified voting results and upload the block to preset branch chains; where, before the supervision node generates the block according to all the voting results verified by the verification node, when a main chain of the blockchain verifies validity of the branch chains by verifying a Merkle tree of a part of the branch chains and the validity of the branch chains is verified, the second uploading unit is configured to generate the block according to all the voting results verified, and upload the block to the part of the branch chains.

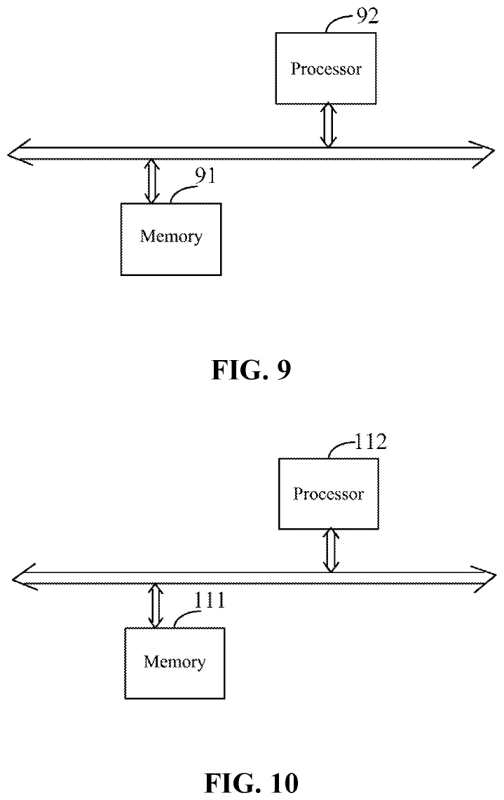

FIG. 9 is a structural schematic diagram of a supervision node according to a ninth embodiment of the present disclosure. As shown in FIG. 9, the supervision node includes a memory 91 and a processor 92; where,

the memory 91 is configured to store instructions executable by the processor 92;

the processor 92 is configured to execute the instructions to implement the blockchain based service information processing method according to any one of the foregoing embodiments.

FIG. 10 is a structural schematic diagram of an evaluating node according to a tenth embodiment of the present disclosure. As shown in FIG. 10, the evaluating node includes a memory 111 and a processor 112; where,

the memory 111 is configured to store instructions executable by the processor 112;

the processor 112 is configured to execute the blockchain based service information processing method according to any one of the foregoing embodiments.

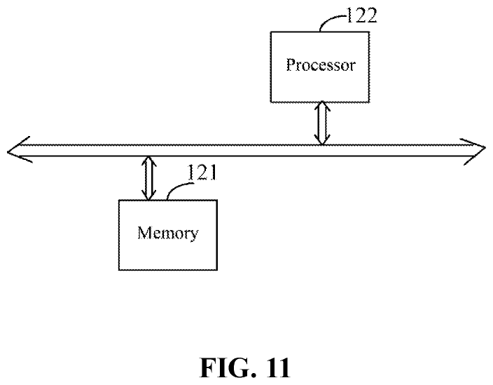

FIG. 11 is a structural schematic diagram of a verification node according to an eleventh embodiment of the present disclosure. As shown in FIG. 11, the verification node includes a memory 121 and a processor 122; where,

the memory 121 is configured to store instructions executable by the processor 122;

the processor 122 is configured to execute the blockchain based service information processing method according to any one of the foregoing embodiments.

Another embodiment of the application further provides a computer readable storage medium, storing thereon computer executable instructions, where the blockchain based service information processing method according to any one of the foregoing embodiments is implemented when the computer executable instructions are executed by a processor.

Another embodiment of the application further provides a computer program including program codes, where the blockchain based service information processing method according to any one of the foregoing embodiments is implemented when the computer program is run by a computer.

Those skilled in the art can clearly understand that for the convenience and conciseness of the description, the specific working process of the device described above may refer to the corresponding process in the foregoing method embodiments, which will not be repeated here.

Those of ordinary skill in the art can understand that all or part of the steps to implement the foregoing method embodiments can be realized by hardware related to program instructions. The foregoing program may be stored in a computer readable storage medium. When the program is executed, the steps included in the foregoing method embodiments are executed. The foregoing storage media include various media that capable of storing program codes, such as a ROM, a RAM, a magnetic disc or an optical disc.

Lastly, it should be noted that the above embodiments are only used to explain the technical solutions of the present disclosure and shall not be construed as limitation. Although the present disclosure has been described in detail with reference to the foregoing embodiments, those of ordinary skill in the art should understand that modifications can still be made to the technical solutions recorded in the foregoing embodiments or some or all technical features thereof may be substituted by their equivalents, and such modifications or substitutions do not cause the nature of the technical solution to deviate from the scope of the technical solutions of the embodiments according to the present disclosure.

What is claimed is:

1. A blockchain based service information processing method, comprising:
sending, by a supervision node, a voting request in a blockchain, wherein the voting request comprises service information and a voting option, and the blockchain comprises the supervision node and at least one evaluation node;
generating, by the supervision node, a block after a preset time according to all voting results verified by a verification node, and uploading the block to the blockchain, wherein the verification node is elected from the at least one evaluation node; and
determining, by the supervision node, according to all the voting results, whether or not to enter a risk evaluation process.

2. The method according to claim 1, wherein the voting request is sent by the supervision node upon detecting generation of a new service.

3. The method according to claim 1, after the generating, by the supervision node, the block according to all the voting results verified by the verification node, and the uploading the block to the blockchain, further comprising:
issuing, according to a preset smart contract, rewards to all evaluation nodes that participate in voting.

4. The method according to claim 3, wherein the issuing, according to the preset smart contract, the rewards to all the evaluation nodes that participate in the voting, comprises:
determining, from all the voting results, an optimal voting option with a highest voting count; and
issuing the rewards to the evaluation nodes according to closeness of voting options of the evaluation nodes to the optimal voting option, wherein the optimal voting option corresponds to a highest reward.

5. The method according to claim 3, wherein the issuing, according to the preset smart contract, the rewards to all the evaluation nodes that participate in the voting, comprises:
determining proportion information of each voting option in all the voting results; and
issuing the rewards to the evaluation nodes according to the proportion information.

6. A blockchain based service information processing method, comprising:
receiving, by an evaluation node, a voting request issued in a blockchain by a supervision node;
broadcasting, by the evaluation node, a voting result in the blockchain according to the voting request; and
electing, by the evaluation node, at least one verification node according to a preset election mechanism such that the verification node verifies all voting results, and uploads to the blockchain; such that the supervision node generates a block according to all the voting results verified by the verification node, and determines, according to all the voting results, whether or not to enter a risk evaluation process.

7. The method according to claim 6, wherein the electing, by the evaluation node, the at least one verification node according to the preset election mechanism, comprises:
determining a quantity of all evaluation nodes that participate in voting and a random number that satisfies a preset condition, wherein the random number is less than the quantity of all the evaluation nodes that participate in the voting; and
selecting, from the evaluation nodes, an evaluation node whose quantity is a difference between the quantity of all the evaluation nodes that participate in the voting and the random number to be the at least one verification node.

8. The method according to claim 7, after the selecting, from the evaluation nodes, the evaluation node whose quantity is the difference between the quantity of all the evaluation nodes that participate in the voting and the random number to be the at least one verification node, further comprising:
selecting an accounting verification node from the at least one verification node through a preset consensus mechanism, such that the accounting verification node generates a block according to all the voting results and link the block to the blockchain.

9. The method according to claim 7, wherein the determining the quantity of all the evaluation nodes that participate in the voting and the random number, comprises:
with respect to each preset time span, determining the quantity of all the evaluation nodes that participate in the voting and the random number.

10. The method according to claim 7, after the selecting, from the evaluation nodes, the evaluation node whose quantity is the difference between the quantity of all the evaluation nodes that participate in the voting and the random number to be the at least one verification node, the method further comprises:
if it is detected that any one of the at least one verification node does not send acknowledge information after a preset time threshold, returning to execution of the step of the determining the quantity of all the evaluation nodes that participate in the voting and the random number, until acknowledge information sent by each of the at least one verification node is received; wherein the evaluation node sends acknowledge information after being selected as a verification node.

11. A blockchain based service information processing method, comprising:
obtaining, by a verification node, voting results sent by all evaluation nodes in a blockchain, wherein the verification node is elected by all the evaluation nodes in the blockchain that participate in voting;
verifying, by the verification node, the voting results with respect to each of the voting results; and
generating, by the verification node, a block according to the verified voting results and uploading the block to the blockchain, such that a supervision node generates a block according to all the voting results verified by the verification node, and determines, according to all the voting results, whether or not to enter a risk evaluation process.

12. The method according to claim 11, wherein the voting results comprise identifiers of evaluation nodes that broadcast the voting results;
accordingly, the verifying, by the verification node, the voting results with respect to each of the voting results, comprises:
determining the evaluation nodes that broadcast the voting results according to the identifiers of the evaluation nodes in the voting results; and
verifying the voting results according to prestored public keys of the evaluation nodes.

13. The method according to claim 11, wherein the verifying, by the verification node, the voting results with respect to each of the voting results, comprises:
verifying, by the verification node, the voting results with respect to each of the voting results in a preset time span.

14. The method according to claim 11, the generating, by the verification node, the block according to the verified voting results and the uploading the block to the blockchain, comprise:
generating, by the verification node, the block according to the verified voting results and uploading the block to a main chain of the blockchain; or,
generating, by the verification node, the block according to the verified voting results and uploading the block to preset branch chains;
wherein the generating, by the verification node, the block according to the verified voting results and uploading the block to preset branch chains, comprises: before the supervision node generates the block according to all the voting results verified by the verification node, when a main chain of the blockchain verifies validity of the branch chains by verifying a Merkle tree of a part of the branch chains and the validity of the branch chains is verified, generating, by the verification node, the block according to all the voting results verified by the verification node, and uploading the block to the part of the branch chains.

15. A supervision node, comprising: a memory and a processor; wherein,
the memory is configured to store instructions executable by the processor;
the processor is configured to execute the instructions to implement the blockchain based service information processing method according to claim 1.

16. An evaluation node, comprising: a memory and a processor; wherein,
the memory is configured to store instructions executable by the processor;
the processor is configured to execute the instructions to implement the blockchain based service information processing method according to claim 6.

17. A verification node, comprising: a memory and a processor; wherein,
the memory is configured to store instructions executable by the processor;
the processor is configured to execute the instructions to implement the blockchain based service information processing method according to claim 11.

18. A computer readable storage medium, storing thereon computer executable instructions, wherein the blockchain based service information processing method according to claim 1 is implemented when the computer executable instructions are executed by a processor.

19. A computer readable storage medium, storing thereon computer executable instructions, wherein the blockchain based service information processing method according to claim 6 is implemented when the computer executable instructions are executed by a processor.

20. A computer readable storage medium, storing thereon computer executable instructions, wherein the blockchain based service information processing method according to claim 11 is implemented when the computer executable instructions are executed by a processor.
